(19) United States
(12) Patent Application Publication
(10) Pub. No.: US 2002/0161866 A1
(43) Pub. Date: Oct. 31, 2002

(54) Method and apparatus for internet-based remote terminal units and flow computers

(76) Inventors: Garnet Tozer, Chestermere (CA); Leslie Day, Calgary (CA); Richard J. Vanderah, Marshalltown, IA (US)

Correspondence Address: CONLEY ROSE & TAYON, P.C., P. O. BOX 3267, HOUSTON, TX, 77253-3267, US

(21) Appl. No.: 10/104,292

(22) Filed: Mar. 20, 2002

Related U.S. Application Data
(60) Provisional application No. 60/277,426, filed on Mar. 20, 2001.

(51) Int. Cl. G06F 15/173; G06F 15/177

(52) U.S. Cl. 709/220; 709/223

(57) ABSTRACT

An improved system and method for an Internet-accessible RTU system is presented. An embodiment of the present invention comprises at least one field sensor device, a RTU connected locally with one or more field sensor devices and configured to transmit data to and receive data from the field sensor devices. The RTU is also configured to be an Internet web server and an email client. A communication device is used in conjunction with the RTU to enable the RTU to transmit and receive data over an Internet connection. The RTU is programmed to process data received from the field sensor devices and communicate the processed data over the Internet connection. A WWW-enabled device is connected to the RTU via the Internet connection and the WWW-enabled device is programmed to transmit data to and receive data from the RTU via the Internet connection.

### CROSS-REFERENCE TO RELATED APPLICATIONS

The present application claims the benefit of 35 U.S.C. 111(b) provisional application Serial No. 60/277,426 filed Mar. 20, 2001, and entitled Method and Apparatus for an Internet-Based Gas Flow Computer.

### STATEMENT REGARDING FEDERALLY SPONSORED RESEARCH OR DEVELOPMENT

Not Applicable.

### BACKGROUND OF THE INVENTION

1. Field of the Invention

The present invention relates generally to systems and methods for accessing remote terminal units (“RTUs”) programmed as flow computers and standalone flow computers. More specifically, the present invention relates to RTU-based flow computers and standalone flow computers that are web-enabled and can be accessed by users using the Internet, an intranet or related technologies. Furthermore, the present invention contemplates a programmable RTU or standalone flow computer that performs functions such as gas measurement calculations, alarm notification, production history data reporting, real-time monitoring and remote configuration and control.

2. Description of the Related Art

RTUs and flow computers have existed for many years. The use of RTUs and flow computers in the prior art for the purpose of sensing, calculating and communication flow information can take one of at least three different forms. In one configuration, as shown in FIG. 1, a prior art integrated unit is depicted where RTU 110 is programmed to act as a flow computer. In another configuration, an RTU and a flow computer may be implemented as separate devices that are connected to each other (such as through a local serial connection). In a third configuration, a flow computer may be implemented as a standalone device that is dedicated to calculating flow and generally operates without utilizing or connecting to an RTU (other than utilizing a communication component which may be adapted from an RTU). Such a standalone flow computer will typically have embedded sensors and does not require field wiring.

The use of the term RTU throughout this application, including but not limited to the specification, drawings, and claims, is intended to include, but not be limited to, any of the foregoing configurations, including a flow computer implemented as a standalone device.

Still referring to FIG. 1, regardless of which one of the foregoing configurations of RTU is used, the RTU 110 may be programmed to calculate the flow of gas through an orifice plate by sensing the static pressure, differential pressure, and temperature of the gas, and calculating the resultant flow according to some complex calculations (such as those published by the American Gas Association). Extracting production data from RTU 110 has typically required either manual intervention or additional layers of technology.

Still referring to the prior art as depicted in FIG. 1, the manual intervention method has required an operator of RTU 110 to read flow data from a display screen 111, and record this information in some other system. Alternatively, the operator would manually initiate a download of flow information from RTU 110 into a locally connected computer 130 (such as a laptop computer) that can transport the data and which may be programmed to perform further manipulation of the data. Laptop 130 is connected to RTU 110 through a local connection, such as serial connection 140.

Other layers of technology have been used in the prior art to automatically gather data from RTU 110. For example, a remote host SCADA (Supervisory Control and Data Acquisition) computer 160 may be used to remotely access the data collected at a field location in RTU 110. As shown in FIG. 1, this scenario requires the use of RTU 110, a wide area communication link 150 (such as phone, cellular, radio, spread spectrum, microwave or satellite), and a SCADA host computer 160 that is remote from RTU 110. In this arrangement, RTU 110 is connected to various field sensors 170 and gathers flow information from the sensors. RTU 110 transmits the flow information to remote host SCADA computer 160 over wide area communication link 150. Host SCADA computer 160 receives the flow data and stores the flow data in its memory. Host SCADA computer 160 is programmed to perform functions such as: alerting the operator to an alarm condition at the flow computer; preparing daily, weekly, or monthly reports on the flow data; providing a near real-time display of the flow computer data; and providing for remote configuration of the flow computer parameters (such as gas composition and meter run dimensions and metallurgy).

### SUMMARY OF THE INVENTION

An embodiment of the present invention comprises an Internet-accessible RTU system and method of using an Internet-accessible RTU system. The embodiment comprises at least one field sensor device, a RTU connected locally with one or more field sensor devices and configured to transmit data to and receive data from the field sensor devices. The RTU is also configured to be an Internet web server and an email client. A communication device is used in conjunction with the RTU to enable the RTU to transmit and receive data over an Internet connection. The RTU is programmed to process data received from the field sensor devices and communicate the processed data over the Internet connection. A WWW-enabled device is connected to the RTU via the Internet connection and the WWW-enabled device is programmed to transmit data to and receive data from the RTU via the Internet connection.

Furthermore, the WWW-enabled device may be used to remotely configure parameters in the RTU. The RTU is identified by a URL address. The RTU is programmed to perform gas flow calculations on data received by the RTU from the field sensor devices. The RTU may be a flow computer. The RTU may be programmed to prepare reports relating to processed data and may send such reports to WWW-enabled devices via email to one or more pre-defined email addresses. The WWW-enabled device may receive alerts, reports, and other data from the RTU in the form of web page formats, e-mail formats, HTML formats or XML formats. The alarm threshold for sending alerts is user-configurable. The WWW-enabled device may be a personal computer, laptop computer or PDA running Internet browser software. The WWW-enabled device may also be a cellular telephone capable of transmitting and receiving data via the Internet connection. The communication device may be any one of the following: CDPD modem, satellite modem, a microwave modem, a spread spectrum modem, a licensed radio frequency modem, a cellular modem or a land-line modem. The communication device may be a device independent from the RTU, but it is locally coupled to the RTU to enable the Internet connection. Alternatively, the communication device may be integrated within the RTU.

A remote host computer may be connected to the RTU via the Internet connection, such that the host computer is programmed to receive periodic data from the RTU via the Internet connection. The host computer is further programmed to analyze the data, parse out various data values, store the parsed data values in a database and manipulate data in the database. The remote host computer may be a WWW-enabled device.

### BRIEF DESCRIPTION OF THE DRAWINGS

For a more detailed description of the preferred embodiment of the present invention, reference will now be made to the accompanying drawings, wherein:

FIG. 1 is a block diagram illustrating prior art RTU and remote host SCADA computer configuration;

FIG. 2 is a block diagram illustrating the preferred embodiment of the present invention;

FIG. 3 is a flow chart depicting the alarm notification logic of the preferred embodiment;

FIG. 4 presents a sample alarm message;

FIG. 5 is a flow chart depicting the data reporting logic of the preferred embodiment;

FIG. 6 presents a sample daily reporting email;

FIGS. 7A through 7F present sample web pages that may be accessed by WWW users;

FIG. 8 is a flow chart depicting the RTU remote configuration logic of the preferred embodiment;

FIG. 9 is a flow chart depicting the RTU remote control logic of the preferred embodiment; and

FIG. 10 is a flow chart depicting logic associated with computer code in a host computer located remotely from the RTU in the preferred embodiment.

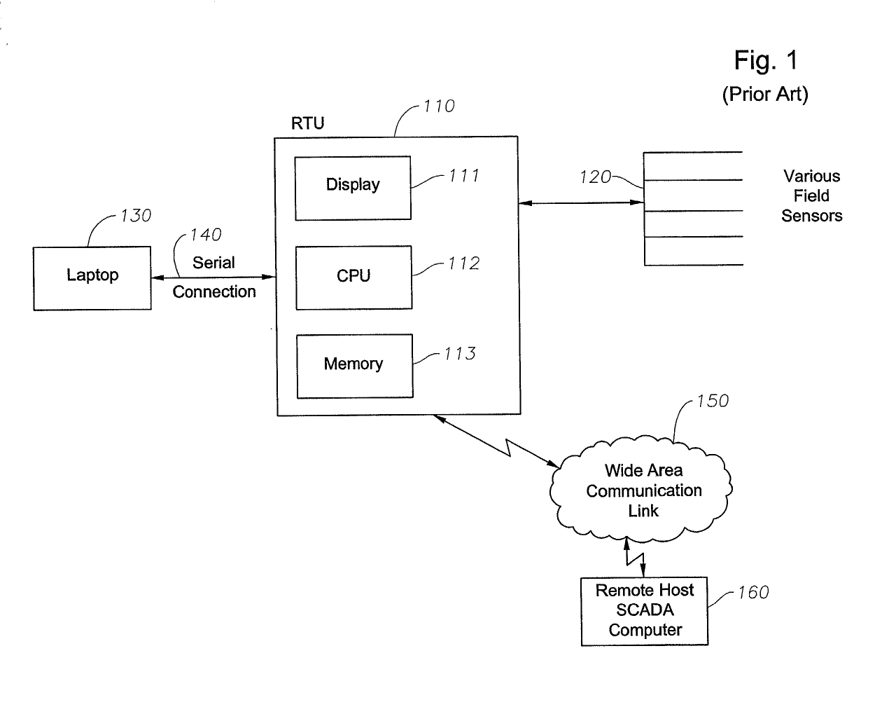

While the present invention is susceptible to various modifications and alternative forms, specific embodiments thereof are shown by way of example in the drawings and will described herein. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENT

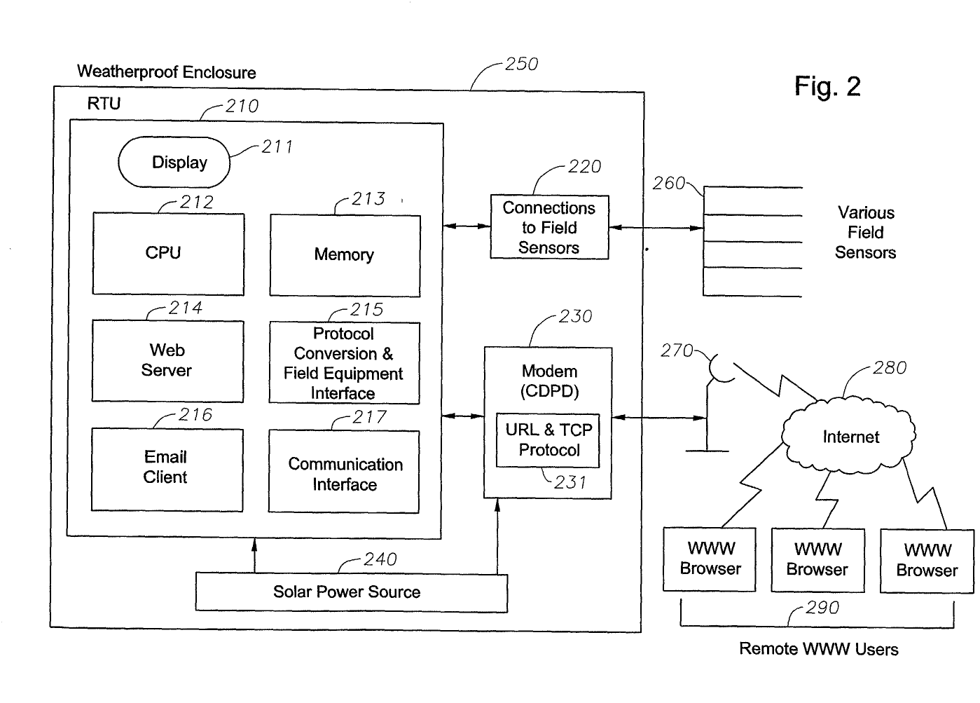

FIG. 2 presents a block diagram of the preferred embodiment of the present invention. The preferred embodiment utilizes proprietary computer code in conjunction with commercially available products and services to create a unique flow measurement and communication method and system. The preferred embodiment of the present invention may be used under adverse environmental and weather conditions. Therefore, the system of the preferred embodiment is encased in a steel weatherproof enclosure 250. However, the present invention does not require the use of such an enclosure. The various components may be mounted separately, mounted in some other enclosure or all of the components in weatherproof enclosure 250 may be totally embedded in RTU 210.

Weatherproof enclosure 250 contains RTU 210, connections to field sensors 220, modem 230 and solar power source 240. RTU 210, among other things described below, is programmed to provide the functionality of a flow computer. Various field sensors 260 (such as a Fisher Rosemount 3095 Multi Variable Sensor) are connected to RTU 210 via connections to field sensors 220. In the preferred embodiment, connection to field sensors 220 is the physical (hard-wire) connection of field sensors 260 to RTU 210, which enables transmission of flow measurement signals from sensors 260 to RTU 210. In an alternative embodiment, such as in the case of a standalone flow computer, direct process connections are made to embedded pressure sensors in the standalone flow computer. RTU 210 receives various gas measurement parameters (such as differential pressure, static pressure, and temperature) via connections 220 from various field sensors 260. RTU 210 is connected to modem 230. Modem 230 is coupled to antenna 270 to enable two-way communications between RTU 220 and remote World Wide Web (WWW) users 290 via the Internet 280. WWW users 290 includes, but it is not limited to, users connected to the Internet 280 using a web browser on a desktop computer or laptop. WWW users 290 also includes users with any WWW-enabled device that provides access to and communication over the Internet 280, including but not limited to, users with cellular telephones, personal digital assistants (PDA) and similar devices that are capable of communicating over the Internet 280.

In the preferred embodiment of the present invention, RTU 210 and modem 230 are powered by solar power source 240. However, the present invention is not limited to the use of solar energy as a power source. As one of ordinary skill in the art will appreciate, other forms of energy may be used as a power source, including but not limited to, a thermo electric generator (TEG) and line power energy.

Still referring to FIG. 2, in the preferred embodiment of the present invention RTU 210 contains display 211, CPU 212, memory 213, web server 214, protocol conversion and field equipment interface 215, email client 216 and communication interface 217. The foregoing is not intended to be a comprehensive listing of all components of the RTU. As one of ordinary skill in the art will appreciate, RTU 210 necessarily contains other components not shown in FIG. 2, such as data buses that transport information between various components. The preferred embodiment of the present invention preferably uses any commercially available RTU 210 unit, which contains features such as: (1) ability to program the RTU unit in the ANSI C language; (2) at least one megabyte of RAM memory 213; (3) at least one RS-232 serial port for communication interface 217; and (4) at least one RS-485 port or three 10-bit analog inputs for connection to various field sensors 260. The present invention is not limited to any particular RTU unit. Any suitable commercially available RTU may be used. Display 211 is a display unit that is integrated within RTU 210. CPU 212 performs various calculations and any other computer processing. Memory 213 includes, but it is not limited to, the use of flash RAM and ROM memory.

Still referring to FIG. 2, the preferred embodiment of the present invention uses Airlink Raven as modem 230, which is commercially available from Airlink Communications, Inc. of Freemont, California. However, the present invention does not require the use of any particular brand and/or model of modem, including the Airlink Raven. Other commercially available CDPD modems with appropriate electrical and environmental ratings may be used. Furthermore, the present invention is not limited to the use of CDPD technology. Any communication device that provides a communication link between RTU 210 and the Internet 280 may be used, including but not limited to, the use of communication technology involving a satellite modem, a microwave modem, a spread spectrum modem, a licensed radio frequency modem, a cellular modem, a land-line modem or any other technology that enables establishment of a communication link between RTU 210 and the Internet 280.

In the preferred embodiment, the Airlink Raven CDPD modem 230 provides a unique URL address for remote access to RTU 210 over the Internet 280. Furthermore, the Airlink Raven CDPD modem 230 also provides the necessary Internet communication protocols, including TCP. However, the present invention does not require that the URL and Internet communication protocols be provided by modem 230 or any other communication device. The URL and Internet communication protocols (such as TCP) may be provided in RTU 210, such as in web server 214.

RTU 210 is programmed to perform various functions and services, including acting as a flow computer to perform various flow calculations, such as calculation of gas volume at standard pressure and temperature. RTU 210 is also programmed to act as a web server 214 and email client 216. RTU 210 also performs protocol conversions and field equipment interface 215 between the field sensors 260 and RTU 210. RTU 210 also provides a communication interface 217 between modem 230 and RTU 210. The process of acquiring digital representations of the current values that field sensors 260 are reading is handled by protocol conversions and field equipment interface 215. This process stores the digital representations of the values field sensors 260 are reading in internal memory 213. This can be accomplished by polling intelligent field sensors 260, such as a Fisher Rosemount 3095, or simple analog to digital conversions of less intelligent sensors. The components of RTU 210, such as web server 214 or email client 216, have access to the same values in internal memory 213. The implementation of the conversion process is within the knowledge of one of ordinary skill in the art.

RTU 210, programmed as a flow computer, performs various gas flow calculations, including but not limited to, American Gas Association AGA3 and AGA8 computations. Calculations necessary for AGA3 and AGA8 computations are within the knowledge of one of ordinary skill in the art. RTU 210 displays the results of calculations on display 211 and/or communicates the results over the Internet 280 to remote WWW users 290.

RTU 210 is also programmed to perform various data logging and reporting functions. For example, in the preferred embodiment of the present invention, RTU 210 stores flow information on an hourly basis with a retention time of 35 days. Information stored includes average hourly temperature, average hourly differential pressure, hourly average static pressure and hourly flow volume. RTU 210 is also programmed to prepare and send daily production reports via email client 216 to WWW users 290. The implementation of email client 216 in connection with web server 214 is within the knowledge of one of ordinary skill in the art. RTU 210 may also be programmed to compile daily production reports over a specified period of time and present a consolidated report in a suitable format. All of the above described functions and reports are provided by way of example and are not intended to limit the scope of the present invention. As one or ordinary skill in the art will readily appreciate, numerous variations to the functions and reports described above may be accomplished without departing from the spirit of the present invention.

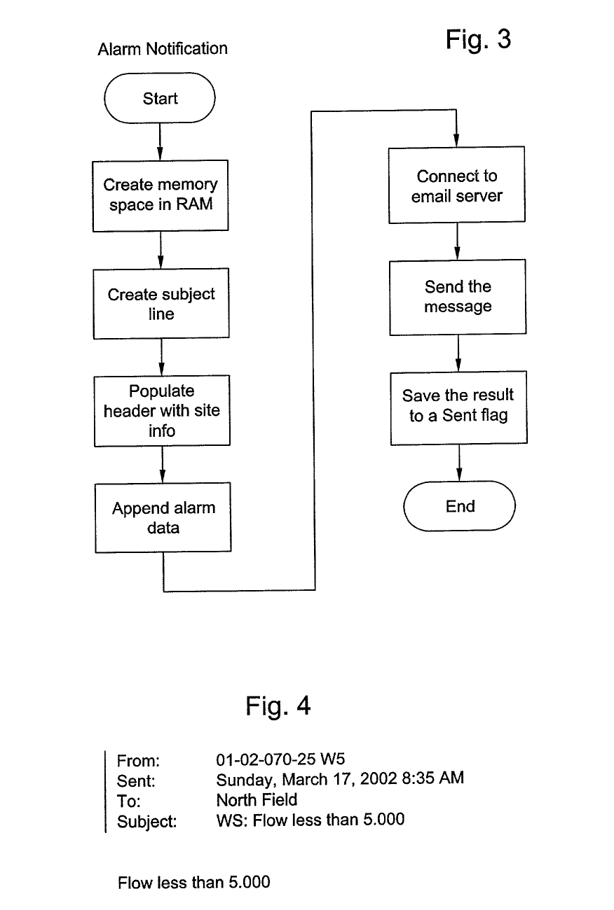

Furthermore, RTU 210 is programmed to send various alerts to WWW users 290 via email client 216 when, for example, the gas flow is in an alarm condition. Referring now to FIG. 3, by way of example, in the preferred embodiment the real-time flow data is continually compared with a pre-set alarm threshold. When the flow rate falls below the alarm threshold, an alarm notification message is generated. Using email client 216, this message is sent out over the Internet 280 in an email format to one or more pre-defined email addresses (remote WWW users 290). The alarm threshold is user-configurable and can be set from zero to fall scale. In the preferred embodiment, the alarm message contains information, including but not limited to: the flow computer name/location, a user-configured alarm message, the alarm flow set point and the current flow rate. FIG. 4 represents a sample alarm message.

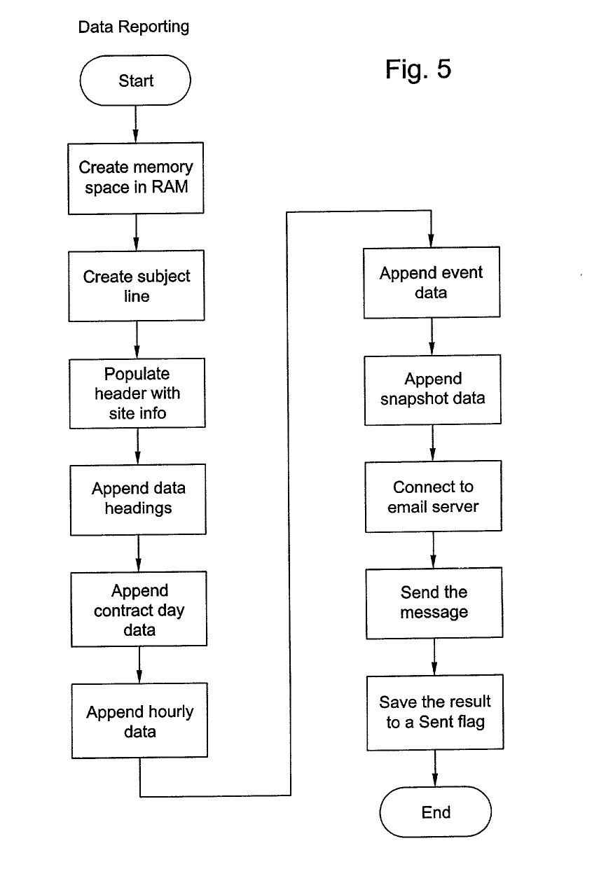

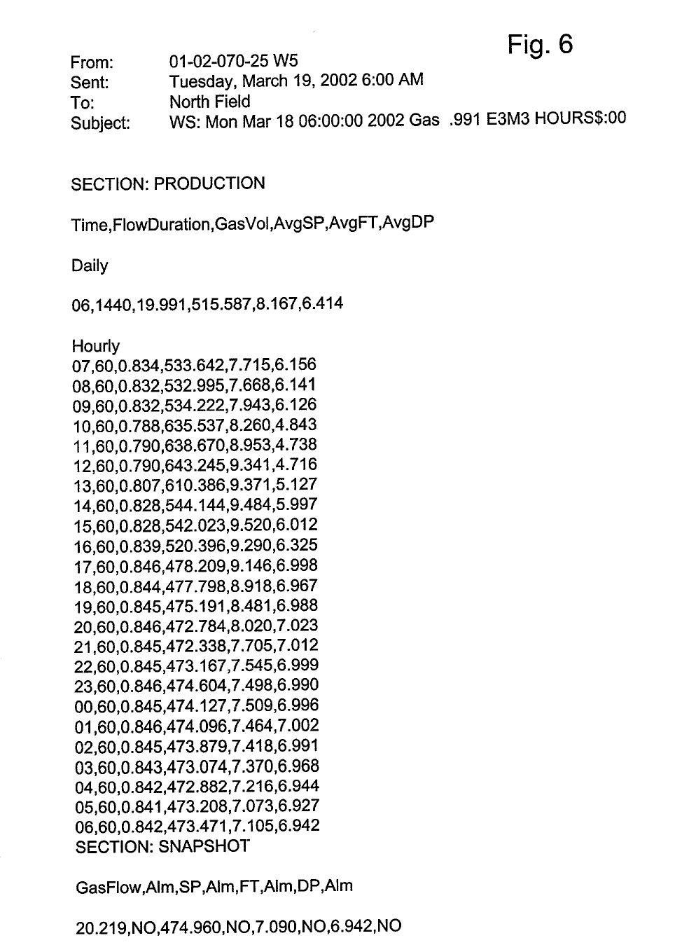

Referring now to FIG. 5, on a daily basis and at a user-defined time of day, RTU 210 of the preferred embodiment produces a report indicating gas flow information, such as gas flow information for the last 24 hours. By way of example, the report indicating gas flow information for the last 24 hours in the preferred embodiment contains 24 records of data, each record containing information such as: average hourly temperature, average hourly differential pressure, hourly average static pressure and hourly flow volume. The report is sent out over the Internet 280 in an email format via email client 216 to one or more pre-defined email addresses to remote WWW users 290. The data contained within the email is preferably in a comma-delimited format. The email preferably contains the production day end date/time, and the daily and 24 hourly readings for each of the following types of measured/calculated parameters: time of day, flow duration (minutes of flow during the time segment), gas volume, average pressure, average temperature and average differential pressure. All of the foregoing description, including report formats, selection of fields of information and timelines are provided by way of example only and are not intended to limit the scope of the present invention. As one or ordinary skill in the art will readily appreciate, numerous variations to the above-described selections may be made without departing from the spirit of the present invention, depending on needs recognized at each RTU 210 installation site. FIG. 6 represents a sample daily reporting email.

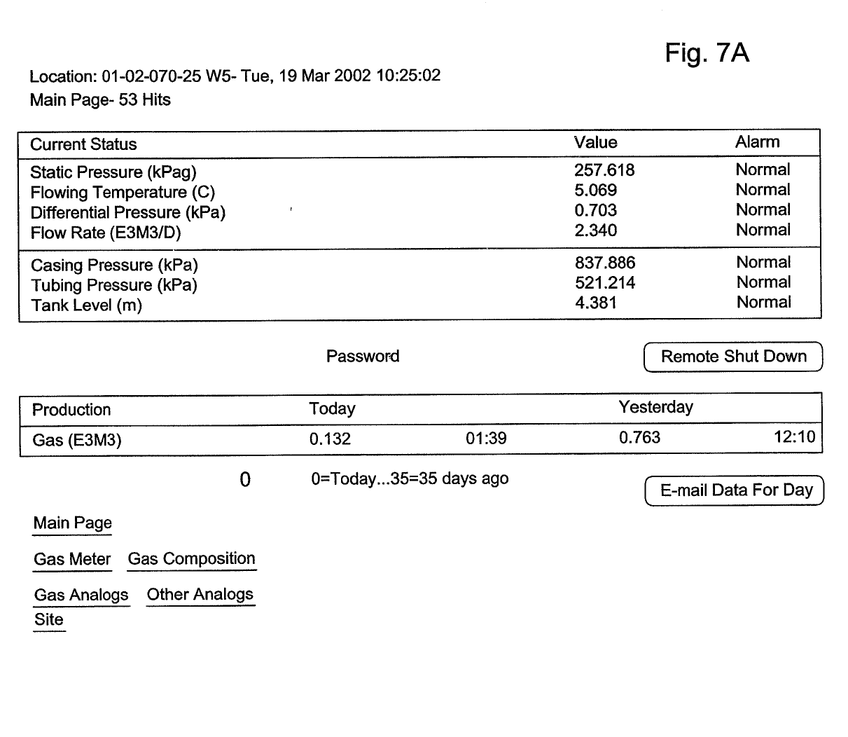

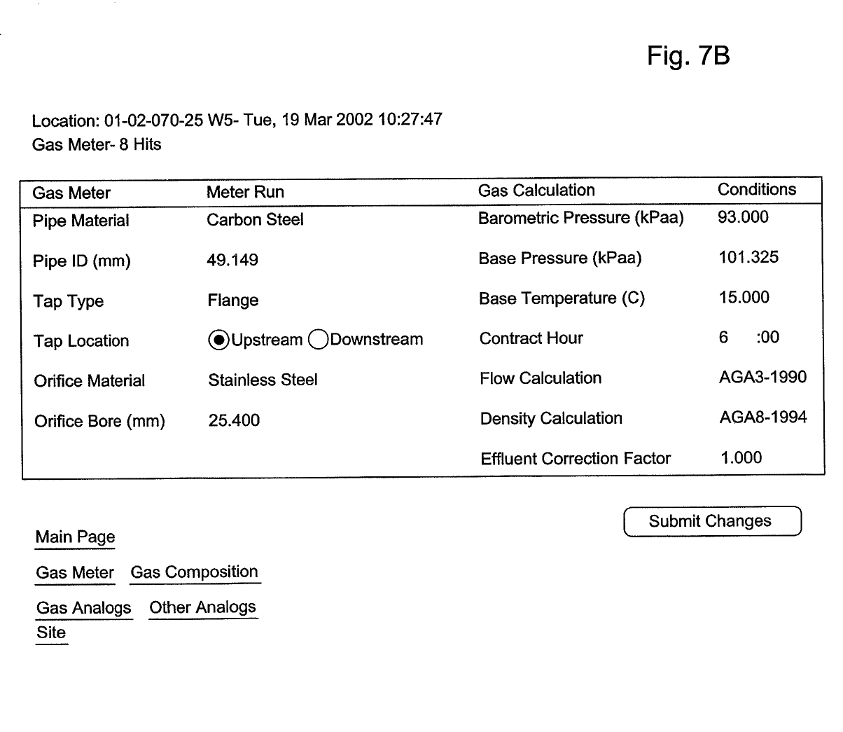

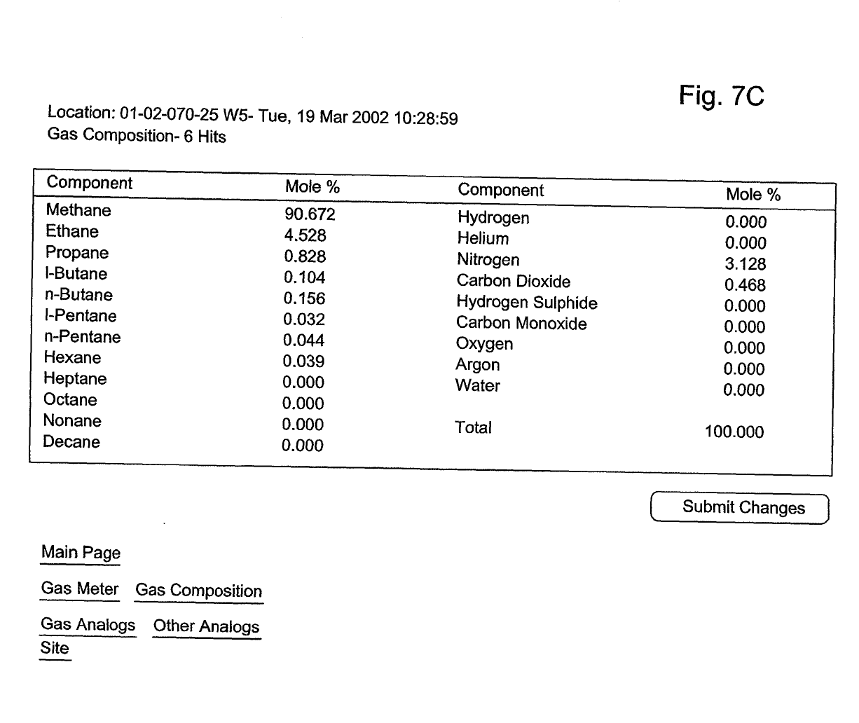

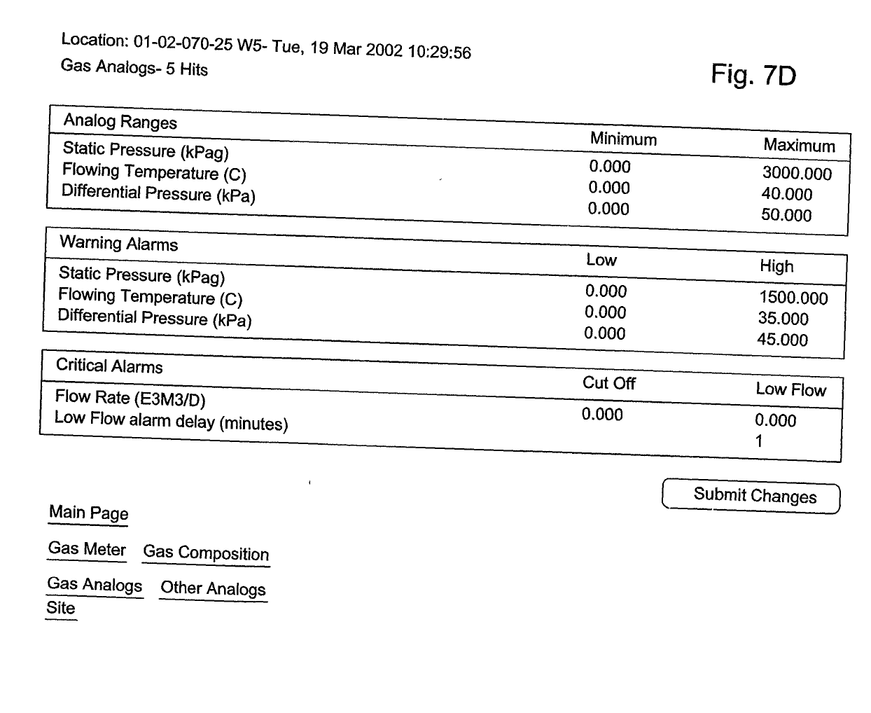

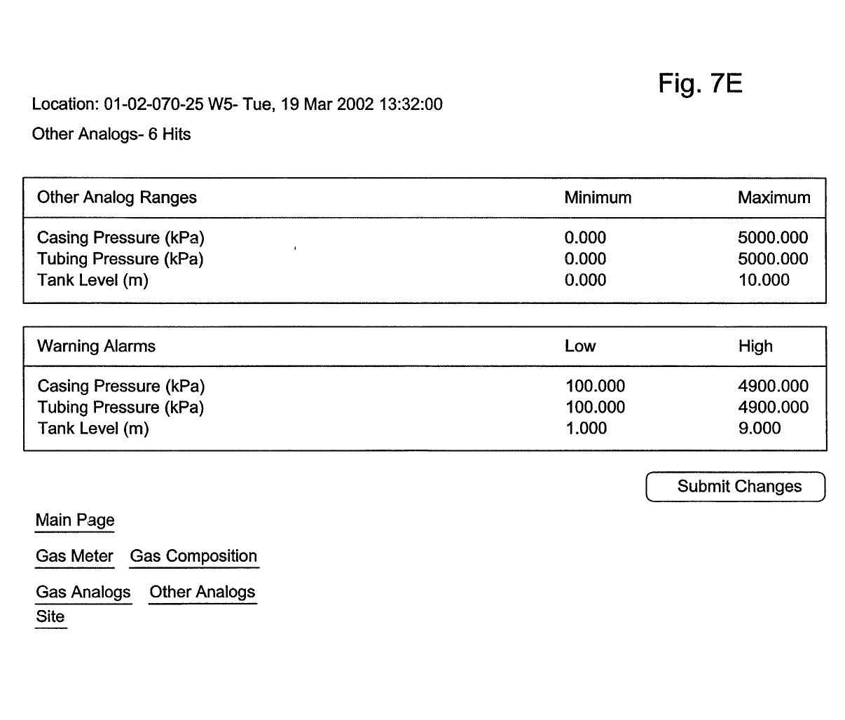

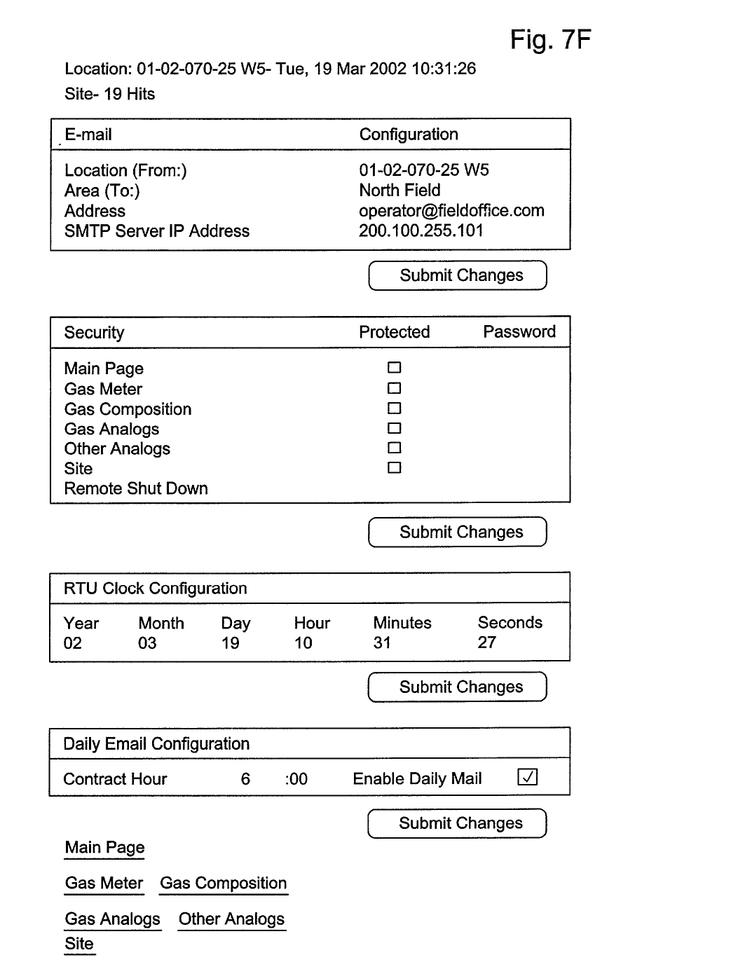

Referring now to FIG. 2, in the preferred embodiment of the present invention, data in RTU 210 may be accessed by remote WWW users 290 over the Internet 280. To access the data in a particular RTU 210, WWW user 290 enters the unique URL assigned to a particular RTU 210. Web server 214 presents the data in RTU 210 to WWW users 290 in an HTML format, XML format or any other recognized format in the users' web browsers. Web server 214 may communicate using HTML, XML or any other format suitable for communication of data over the Internet 280. The implementation of web server 214 in the context of the present invention is within the knowledge of one of ordinary skill in the art. Any type of web browser may be used, including Microsoft Internet Explorer or Netscape Navigator. As previously explained, each RTU 210 is assigned a unique URL. By accessing the URL of RTU 210, a WWW user 290 is able to view information within the RTU (subject to password-protected security). Information that may be viewed through a web browser includes, but it is not limited to: real-time flow information (pressure, temperature, volume, flow rate), gas calculation parameters (gas composition and meter run), alarm set-points, access control, and alarm notification addresses. FIGS. 7A through 7F present sample web pages that may be accessed by WWW users 290. Once again, the selection of web pages and the content of each web page in FIGS. 7A through 7F is provided by way of example and it is not intended to limit the scope of the present invention. As one or ordinary skill in the art will readily appreciate, numerous variations to the web pages and their content may be made without departing from the spirit of the present invention.

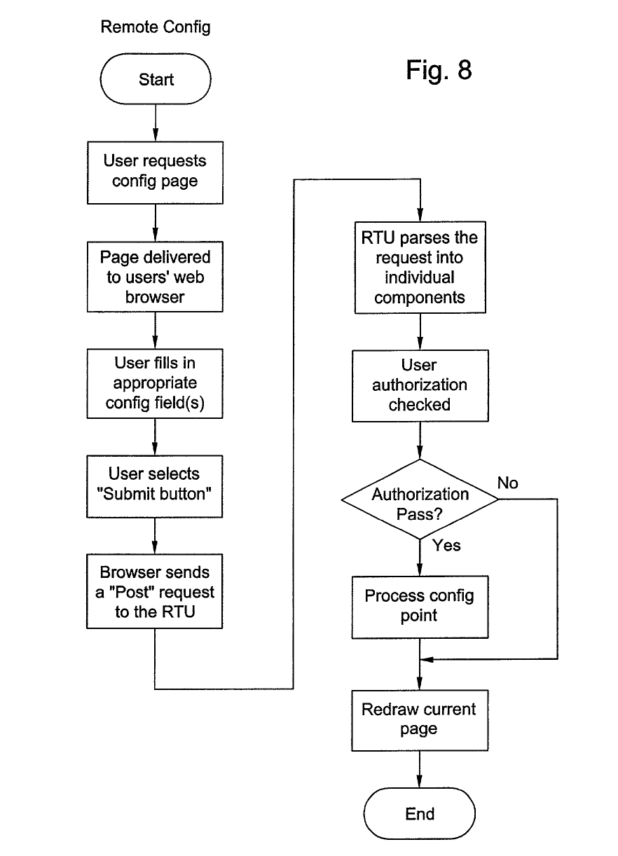

Referring now to FIG. 8, in the preferred embodiment of the present invention, a WWW user 290 may use a web browser to configure RTU 210 remotely over the Internet 280. Referring now to FIGS. 7B through 7F, the following is an illustrative list of the types of parameters in RTU 210 that may be configured by WWW user 290: meter run parameters (pipe inside diameter, tap location, orifice bore diameter, barometric pressure, base pressure, base temperature); end of day time (contract hour); effluent correction factor (for measuring “wet” gas); composition of measured gas (mole % of: methane, ethane, propane, i-butane, n-butane, i-pentane, n-butane, hexane, heptane, octane, nonane, decane, hydrogen, helium, nitrogen, carbon dioxide, hydrogen sulfide, carbon monoxide, oxygen, argon, and water); transmitter ranges (minimum and maximum engineering units range of: static pressure, flowing temperature, and differential pressure); warning alarms (high and low alarm set-points for: static pressure, flowing temperature, and differential pressure); low flow cutoff (stops computation of the gas flow due to a low differential pressure across the orifice plate-this stops the creation of erroneous data); critical alarm set-point (low flow alarm threshold which generates the email alarm notification); E-mail parameters (From name, To name, To Email Address, and SMTP server IP address); web server access control (protection enable/disable for: Main Page, Gas Meter, Gas Composition, Gas Analogs, and Site); web server password configuration (a unique password may be entered for each of the following pages: Main Page, Gas Meter, Gas Composition, Gas Analogs, and Site; and for the Remote Shutdown command); and flow computer real-time clock (year, month, day, hour, minute, second). The foregoing selection of types of parameters that may be remotely configured is provided by way of example and it is not intended to limit the scope of the present invention. As one or ordinary skill in the art will readily appreciate, numerous variations in the selection and types of parameters may be made without departing from the spirit of the present invention.

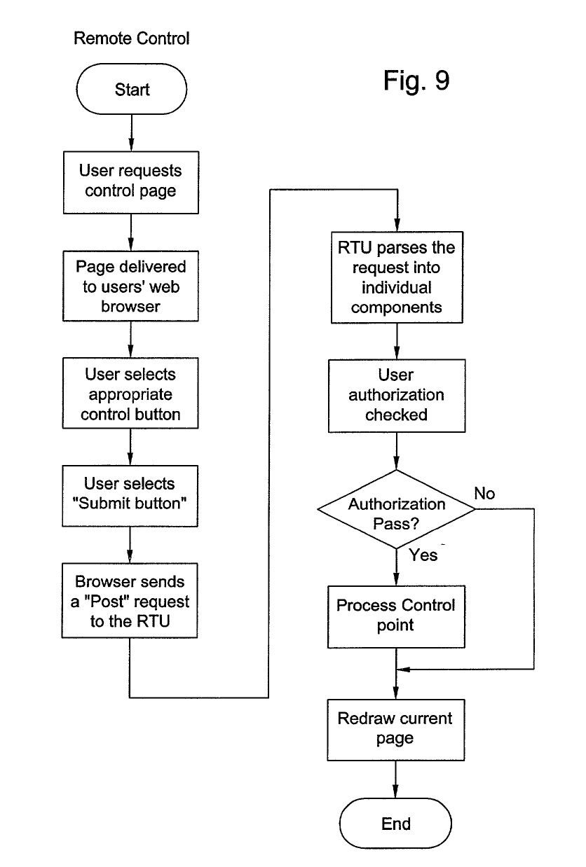

Referring now to FIG. 9 and FIG. 7A, in the preferred embodiment of the present invention, a WWW user 290 from a remote location using a web browser over the Internet 280 may, with proper password protection, take control actions, including but not limited to: (i) remote shut down-this action will stop the flow of gas at a particular RTU 210 location by causing an electrically controlled valve, connected to RTU 210 via connections to field sensors 220, to change state; and (ii) initiate email data delivery-this action allows WWW user 290 to instruct RTU 210 to send, via web server 214 and email client 215, an email containing, for example, the daily flow data report for any of the last 35 days. The foregoing selection of remote control actions and related parameters is provided by way of example and it is not intended to limit the scope of the present invention. As one or ordinary skill in the art will readily appreciate, numerous variations in control actions and related parameters may be made without departing from the spirit of the present invention.

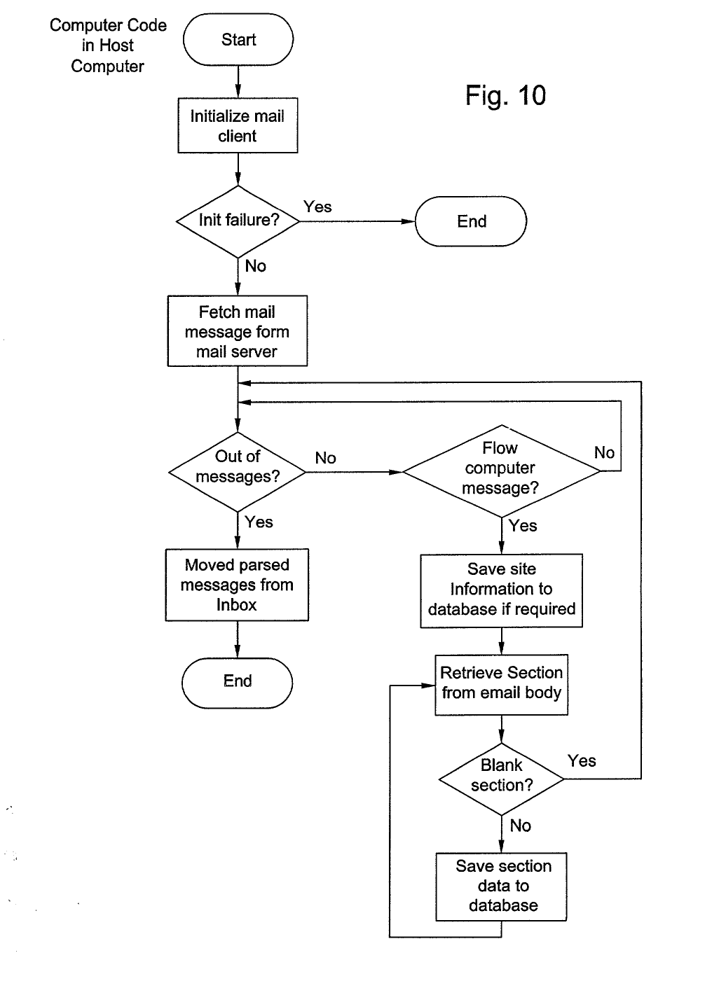

Referring now to FIG. 10, in an optional component of the preferred embodiment of the present invention, certain computer code runs on a host computer located remotely from RTU 210. The remote host computer may be a WWW user 290 or some other remotely connected computer. The host computer code receives daily production reports from the RTU 210. It analyzes the body of the message in order to determine what data is available. The data is first broken down into blocks. Each block starts with a section header describing the next lines of text. The second line of each section contains the field headings for the data that follows. The data lines contain the actual values of information separated by commas. There is no limit to the number of blocks of data that can be included in a message. The host computer code parses out the values, and stores the data in a relational database. The host computer code is programmed to manipulate the data within the database and provide functions including, but not limited to: filtering, reporting, and graphing. The host computer code preferably works with Microsoft Windows 95/98/NT/2000/XP operating systems and Microsoft Outlook email program.

While preferred embodiments of this invention have been shown and described, modifications thereof can be made by one skilled in the art without departing from the spirit or teaching of this invention. The embodiments described herein are exemplary only and are not limiting. Many variations and modifications of the system and apparatus are possible and are within the scope of the invention. Accordingly, the scope of protection is not limited to the embodiments described herein, but is only limited by the claims which follow, the scope of which shall include all equivalents of the subject matter of the claims.

What is claimed is:

1. An Internet-accessible RTU system, comprising:
at least one field sensor device;
a RTU connected locally with said at least one field sensor device and configured to transmit data to and receive data from said at least one field sensor device;
said RTU is also configured to be an Internet web server and an email client;
a communication device, wherein said communication device enables said RTU to transmit and receive data over an Internet connection;
said RTU is programmed to process said data received from said at least one field sensor device and communicate said processed data over said Internet connection; and
a WWW-enabled device connected to said RTU via said Internet connection, wherein said WWW-enabled device is programmed to transmit data to and receive data from said RTU via said Internet connection.

2. An Internet-accessible RTU system as in claim 1, wherein said WWW-enabled device may be used to remotely configure parameters in said RTU via said Internet connection.

3. An Internet-accessible RTU system as in claim 1, wherein said RTU is identified by a URL address.

4. An Internet-accessible RTU system as in claim 1, wherein said WWW-enabled device receives data from said RTU in a web page format.

5. An Internet-accessible RTU system as in claim 1, wherein said WWW-enabled device receives e-mail from said RTU containing information received by said RTU from said at least one field sensor device.

6. An Internet-accessible RTU system as in claim 1, wherein said WWW-enabled device is a personal computer, laptop computer or PDA running Internet browser software.

7. An Internet-accessible RTU system as in claim 1, wherein said WWW-enabled device is a cellular telephone capable of transmitting and receiving data via said Internet connection.

8. An Internet-accessible RTU system as in claim 1, wherein said processed data includes emails, reports and alerts, wherein said emails, reports and alerts are transmitted by said RTU to said WWW-enabled device over said Internet connection.

9. An Internet-accessible RTU system as in claim 1, wherein said RTU is enclosed in a weatherproof enclosure.

10. An Internet-accessible RTU system as in claim 1, wherein said communication device is any one of the following: CDPD modem, satellite modem, a microwave modem, a spread spectrum modem, a licensed radio frequency modem, a cellular modem or a land-line modem.

11. An Internet-accessible RTU system as in claim 10, wherein said communication device is an independent communication device from said RTU, but wherein said communication device is locally coupled to said RTU to enable said Internet connection.

12. An Internet-accessible RTU system as in claim 11, wherein said RTU is programmed to provide communication interface between said independent communication device and said RTU.

13. An Internet-accessible RTU system as in claim 10, wherein said communication device is integrated within said RTU.

14. An Internet-accessible RTU system as in claim 1, wherein said communication device provides Internet communication protocols.

15. An Internet-accessible RTU system as in claim 1, wherein said web server provides Internet communication protocols.

16. An Internet-accessible RTU system as in claim 1, wherein said RTU is programmed to provide protocol conversions and field equipment interface between said at least one field sensor device and said RTU.

17. An Internet-accessible RTU system as in claim 1, wherein said RTU is programmed to perform gas flow calculations on said data received from said at least one field sensor device.

18. An Internet-accessible RTU system as in claim 17, wherein said RTU is a flow computer.

19. An Internet-accessible RTU system as in claim 1, wherein said RTU is programmed to perform logging of said data received from said at least one field sensor device.

20. An Internet-accessible RTU system as in claim 1, wherein said RTU is programmed to prepare reports relating to said processed data and send said reports to said WWW-enabled devices via email to one or more pre-defined email addresses via said Internet connection.

21. An Internet-accessible RTU system as in claim 1, wherein said RTU is programmed to send alerts relating to said processed data to said WWW-enabled devices via email to one or more pre-defined email addresses via said Internet connection.

22. An Internet-accessible RTU system as in claim 21, wherein the alarm threshold for sending said alerts is user-configurable.

23. An Internet-accessible RTU system as in claim 1, wherein user of said WWW-enabled device connects to said RTU via said Internet connection by entering into web browser of said WWW-enabled device the URL assigned to said RTU, wherein said user and said RTU transmit and receive information relating to said RTU and said at least one field sensor device.

24. An Internet-accessible RTU system as in claim 23, wherein said information transmitted between said user and said RTU is in web page format, HTML format or XML format.

25. An Internet-accessible RTU system, comprising:
at least one field sensor device;
a RTU connected locally with said at least one field sensor device and configured to transmit data to and receive data from said at least one field sensor device;
said RTU is also configured to be an Internet web server and an email client;
a communication device, wherein said communication device enables said RTU to transmit and receive data over an Internet connection;
said RTU is also programmed to process said data received from said at least one field sensor device and communicate said processed data over said Internet connection; and
a remote host computer connected to said RTU via said Internet connection, wherein said remote host computer is programmed to receive periodic data from said RTU via said Internet connection, wherein said host computer is further programmed to analyze said data, parse out various data values, store said parsed data values in a database and manipulate data in said database.

26. An Internet-accessible RTU system as in claim 25, wherein said remote host computer is a WWW-enabled device.

27. A method of use of an Internet-accessible RTU, comprising:
connecting RTU locally with at least one field sensor device;
configuring said RTU to transmit data to and receive data from said at least one field sensor device;
further configuring said RTU to be an Internet web server and an email client;
connecting a communication device to said RTU, wherein said communication device enables said RTU to transmit and receive data over an Internet connection;
programming said RTU to process said data received from said at least one field sensor device and communicating said processed data over said Internet connection; and
connecting a WWW-enabled device to said RTU via said Internet connection, wherein said WWW-enabled device is programmed to transmit data to and receive data from said RTU via said Internet connection.

28. The method of claim 27, wherein said WWW-enabled device may be used to remotely configure parameters in said RTU via said Internet connection.

29. The method of claim 27, wherein said RTU is identified by a URL address.

30. The method of claim 27, wherein said WWW-enabled device receives data from said RTU in a web page format.

31. The method of claim 27, wherein said WWW-enabled device receives e-mail from said RTU containing information received by said RTU from said at least one field sensor device.

32. The method of claim 27, wherein said WWW-enabled device is a personal computer, laptop computer or PDA running Internet browser software.

33. The method of claim 27, wherein said WWW-enabled device is a cellular telephone capable of transmitting and receiving data via said Internet connection.

34. The method of claim 27, wherein said processed data includes emails, reports and alerts, wherein said emails, reports and alerts are transmitted by said RTU to said WWW-enabled device over said Internet connection.

35. The method of claim 27, wherein said RTU is enclosed in a weatherproof enclosure.

36. The method of claim 27, wherein said communication device is any one of the following: CDPD modem, satellite modem, a microwave modem, a spread spectrum modem, a licensed radio frequency modem, a cellular modem or a land-line modem.

37. The method of claim 36, wherein said communication device is an independent communication device from said RTU, but wherein said communication device is locally coupled to said RTU to enable said Internet connection.

38. The method of claim 37, wherein said RTU is programmed to provide communication interface between said independent communication device and said RTU.

39. The method of claim 36, wherein said communication device is integrated within said RTU.

40. The method of claim 27, wherein said communication device provides Internet communication protocols.

41. The method of claim 27, wherein said web server provides Internet communication protocols.

42. The method of claim 27, wherein said RTU is programmed to provide protocol conversions and field equipment interface between said at least one field sensor device and said RTU.

43. The method of claim 27, wherein said RTU is programmed to perform gas flow calculations on said data received from said at least one field sensor device.

44. The method of claim 43, wherein said RTU is a flow computer.

45. The method of claim 27, wherein said RTU is programmed to perform logging of said data received from said at least one field sensor device.

46. The method of claim 27, wherein said RTU is programmed to prepare reports relating to said processed data and send said reports to said WWW-enabled devices via email to one or more pre-defined email addresses via said Internet connection.

47. The method of claim 27, wherein said RTU is programmed to send alerts relating to said processed data to said WWW-enabled devices via email to one or more pre-defined email addresses via said Internet connection.

48. The method of claim 47, wherein the alarm threshold for sending said alerts is user-configurable.

49. The method of claim 27, wherein user of said WWW-enabled device connects to said RTU via said Internet connection by entering into web browser of said WWW-enabled device the URL assigned to said RTU, wherein said user and said RTU transmit and receive information relating to said RTU and said at least one field sensor device.

50. The method of claim 49, wherein said information transmitted between said user and said RTU is in web page format, HTML format or XML format.

51. A method of use of an Internet-accessible RTU system, comprising:
connecting a RTU locally with at least one field sensor device and configuring said RTU to transmit data to and receive data from said at least one field sensor device;
configuring said RTU to be an Internet web server and an email client;
connecting a communication device to said RTU, wherein said communication device enables said RTU to transmit and receive data over an Internet connection;
programing said RTU to process said data received from said at least one field sensor device and communicating said processed data over said Internet connection; and
connecting a remote host computer to said RTU via said Internet connection, wherein said remote host computer is programmed to receive periodic data from said RTU via said Internet connection, wherein said host computer is further programmed to analyze said data, parse out various data values, store said parsed data values in a database and manipulate data in said database.

52. The method of claim 51, wherein said remote host computer is a WWW-enabled device.
